(19) United States
(12) Patent Application Publication
(10) Pub. No.: US 2022/0234343 A1
(43) Pub. Date: Jul. 28, 2022

(54) RUBBER PRODUCT WITH A PRINTED SURFACE AND METHOD FOR FORMING A PRINTED SURFACE ON THE SAME

(71) Applicant: DONGGUAN QINJIN MOULD PLASTIC CO., LTD., DONGGUAN (CN)

(72) Inventor: YI-SHENG CHANG, DONGGUAN (CN)

(21) Appl. No.: 17/158,029

(22) Filed: Jan. 26, 2021

(51) Int. Cl. B32B 38/00; B32B 3/30; B32B 25/04; B32B 25/08; B32B 38/04

(52) U.S. Cl. CPC B32B 38/145; B32B 3/30; B32B 2255/10; B32B 25/08; B32B 38/04; B32B 25/042

(57) ABSTRACT

A rubber product having a printed surface includes a base and a printed surface layer on the base. The printed surface layer is printed on a plate beforehand by way of printing using inks containing a rubber material. The plate and the printed surface layer are pre-heated for the printed surface layer to be formed on the plate. The plate and a natural rubber material are simultaneously placed inside a die assembly and are heated and pressed for the natural rubber material to form a base through a sulfurization process of the natural rubber material. The printed surface layer and the base are fused during the sulfurization process to form the rubber product with the printed surface ensuring better resistance against abrasion and corrosion.

### TECHNICAL FIELD

The present invention is related to a rubber product with a printed surface and a method for forming a printed surface on the rubber product, rendering the printed surface of the rubber product more resistant against abrasion and corrosion.

### BACKGROUND

Conventional rubber products or key buttons normally take the form of a casing sheathed by a rubber layer around the casing. Such rubber layer is mainly applied to the conventional rubber products or key buttons that are adopted in televisions or electronic products but are not limited thereto and only serves to shed light on the scope of applications for key buttons in the present invention. Basically, the resilient nature of the rubber layer makes itself not a perfect material to be printed unless it undergoes a sulfurization process arising from a heating and pressing process. Despite higher degree of resilience, the crosslinking reaction in the sulfurization process also hardens the surface of the rubber layer to result in a fixed form required for printing. Also because of the increased temperature and pressure in the sulfurization process, the rubber layer is usually carried out a form pressing while it is heated. In other words, the rubber layer is placed between a male (lower) die and a female (upper) die to be stamped to a designated form before moving on to subsequent printing operation simply because all protruded areas have their intended forms for most of the key buttons after the pressing and then facilitate the printing operation, which is the conventional 2-dimensional screen printing, on their surface. In the event of special demand, background color can be done by spray painting first before a baking process. If needed, a second baking process is performed after the printing or even numerous printing and baking processes may be involved. It is known that the rubber layer should have a fixed form before color printing on its surface. As the rubber layer gets deformed and hardened after several rounds of baking process, most of conventional printing methods employ single-color printing to ensure the yield of finished products. For sake of one baking process for one color printed on a product, the size of the product varies with many baking processes because the size is changed by evaporation of organic materials in each baking process. Such size variation is proportional to the number of baking process and causes a lower yield of the product accordingly. Consequently, the printing operation can only be manually conducted in a piece-by-piece fashion, which in turns leads to a higher production cost and impacts automation of overall production process.

Furthermore, as disclosed in Chinese Utility Model No. CNS2459162Y, a method transfer-printing a pattern on a rubber product includes printing the pattern on a transfer paper in advance, simultaneously placing a natural rubber material and the transfer paper into a die assembly, pressing the natural rubber material through a sulfurization process at high temperature and pressure, and transfer-printing the pattern on the transfer paper onto the rubber product in the course of the press-forming. Such method transfer-printing the pattern on the transfer paper relies on adhesive on the transfer paper for the transfer paper to be directly attached to the rubber product at high temperature and pressure. However, when being subject to high temperature and pressure in the die assembly, the transfer paper is prone to retraction, which further deforms the pattern on the transfer paper. Moreover, as being also stuck on the rubber product with the adhesive, the pattern on the transfer paper may easily come off when it is rubbed and can be worn out easily if the rubber product is used in a frequent manner.

In view of the foregoing disadvantages of the conventional rubber products, how to provide a printed layer on the surface on a rubber product with more abrasion resistance and a printing method in fulfillment of production automation becomes a substantial issue to be tackled.

### SUMMARY

An objective of the present invention is to provide a rubber product with a printed surface and a method for forming the printed surface on the rubber product for a printed surface layer of the rubber product to have better resistance against abrasion and corrosion.

To achieve the foregoing objective, the rubber product with a printed surface includes a base and a printed surface layer.

The base is made of a natural rubber material undergoing a sulfurization process.

The printed surface layer has the printed surface on the base and formed by ink made of the natural rubber material and is fused with the base after the printed surface layer and the base are heated and pressed.

Preferably, the printed surface layer has at least one color formed thereon.

Preferably, the printed surface layer has at least one key button region or at least one label region formed thereon.

Preferably, the printed surface layer is printed by way of multi-layer printing.

To achieve the foregoing objective, the method for forming a printed surface on a rubber product includes:

a pre-printing step forming a printed surface layer on each of at least one plate heated and pre-shrunk beforehand, in which the printed surface layer on each of the at least one plate is printed on the plate with inks containing a natural rubber material;

a pre-shrinking step heating the at least one plate for the printed surface layer on each of the at least one plate to be shrunk to a designated form;

a fusing step simultaneously placing the at least one plate and a substrate made of the natural rubber material into a die assembly with the printed surface layer on each of the at least one plate adjacent to the substrate, heating and pressing the at least one plate and the substrate inside the die assembly at the same time for the substrate to form a base through a sulfurization process, and fusing adjacent surfaces of the base and the printed surface layer on each of the at least one plate together during the sulfurization process to form a preliminary workpiece; and

a cutting step cutting the preliminary workpiece into a predetermined shape to form the rubber product with the at least one printed surface layer.

Preferably, the at least one plate is made of a material that has a melting point higher than that of the natural rubber material and is selected from one of PC (Polycarbonate), TPU (Thermoplastic Polyurethane), PET (Polyethylene Terephthalate).

Preferably, in the pre-printing step, each of the at least one printed surface layer having at least one pattern is formed on one of the at least one plate and each of the at least one pattern is printed with multiple colors.

Preferably, in the cutting step, the preliminary workpiece is cut when the preliminary workpiece is inside or removed from the die assembly.

Preferably, the method further includes a separating step removing the at least one plate from the at least one printed surface layer respectively after the preliminary workpiece is formed.

Preferably, the at least one plate includes one plate with one printed surface layer formed on the plate.

Preferably, the at least one plate includes two plates with two printed surface layers formed on the respective plates and the two printed surface layers are arranged to be adjacent to two opposite sides of the substrate in the fusing step.

In contrast to conventional techniques, the rubber product formed by the present invention has the following advantages:

Because both the printed surface layer and the base contain the natural rubber material, the natural rubber material allows the printed surface layer and the base to be fused together due to fused connection out of the sulfurization process, thereby not only increasing the capability against abrasion but providing better resistance against corrosion and more decent waterproof effect for the printed surface layer.

Besides single-sided printing, two plates with two printed surface layers formed thereon respectively can be arranged on two opposite sides of the substrate made of the natural rubber material to further achieve double-sided printing on the substrate at the same time.

### BRIEF DESCRIPTION OF THE DRAWINGS

Other objectives, advantages and novel features of the invention will become more apparent from the following detailed description when taken in conjunction with the accompanying drawings.

FIG. 1 is a 3D schematic diagram showing a rubber product with a printed surface in accordance with the present invention;

FIG. 2 is a side view of the rubber product in FIG. 1;

FIG. 3 is a cross-sectional view of the rubber product in FIG. 1;

FIG. 4 is a flow diagram showing a method for forming a printed surface on a rubber product in accordance with the present invention;

FIG. 5 is a 3D schematic diagram showing a plate and a printed surface layer in accordance with the present invention;

FIG. 6 is an exploded schematic diagram showing the plate and the printed surface layer in FIG. 5;

FIG. 7 is a side view showing the plate and the printed surface layer in FIG. 5;

FIG. 8 is a side view in partial section showing that a plate and a natural rubber material are placed inside a die assembly;

FIG. 9 is a side view in partial section showing that the plate and the printed surface layer in FIG. 8 are separated;

FIG. 10 is a schematic diagram showing a bridging layer formed between a plate and a printed surface layer in accordance with the present invention;

FIG. 11 is a side view in partial section showing that a plate and a printed surface layer are simultaneously formed on a base in accordance with the present invention;

FIG. 12 is a schematic diagram showing that a plate and a natural rubber material are made in a strip from in accordance with the present invention;

FIG. 13 is a side view in partial section showing two printed surface layers formed on a natural rubber material in accordance with the present invention;

FIG. 14 is a cross-sectional view showing a plate adopting multi-colored printing in accordance with the present invention; and

FIG. 15 is a cross-sectional view showing a plate adopting 3D printing in accordance with the present invention.

### DETAILED DESCRIPTION

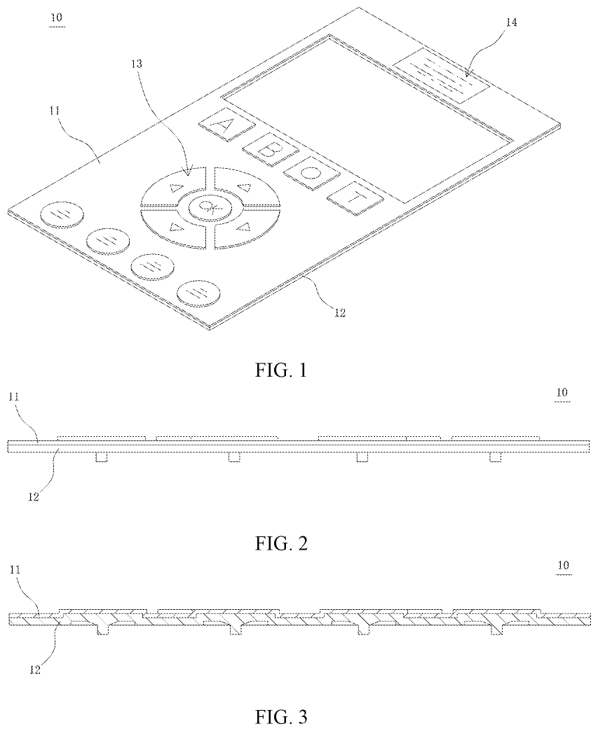

With reference to FIGS. 1 to 3, a rubber product with a printed surface is shown. The rubber product 10 includes a base 11 and a printed surface layer 12. The base 11 is made of a natural rubber material that undergoes a sulfurization process. The printed surface layer 12 is printed beforehand with different colored inks made of the natural rubber material, such that the printed surface layer 12 can demonstrate variation in color and have at least one pattern or at least one label formed thereon. Surfaces of the printed surface layer 12 and the base 11 that are adjacent to each other are fused together through the sulfurization process. Upon the sulfurization process, the rubber product 10 can have portions thereon varying in height, such as a key button region 13 and a label region 14 formed on the rubber product 10.

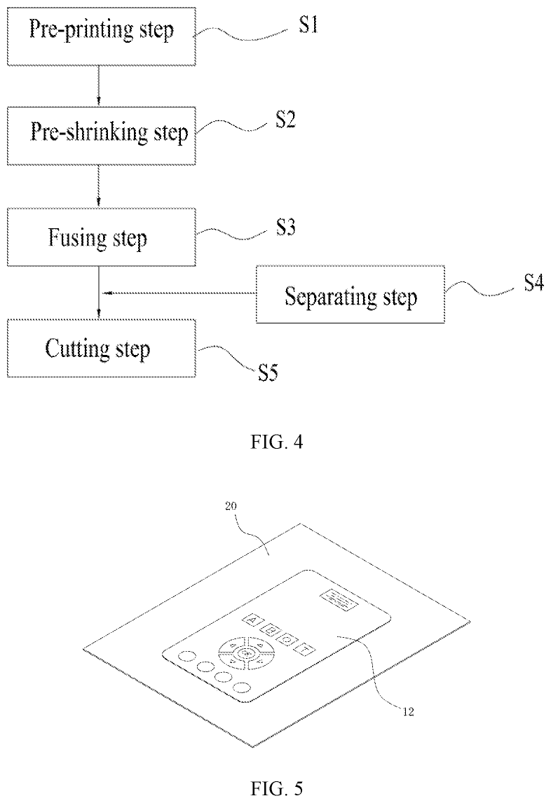

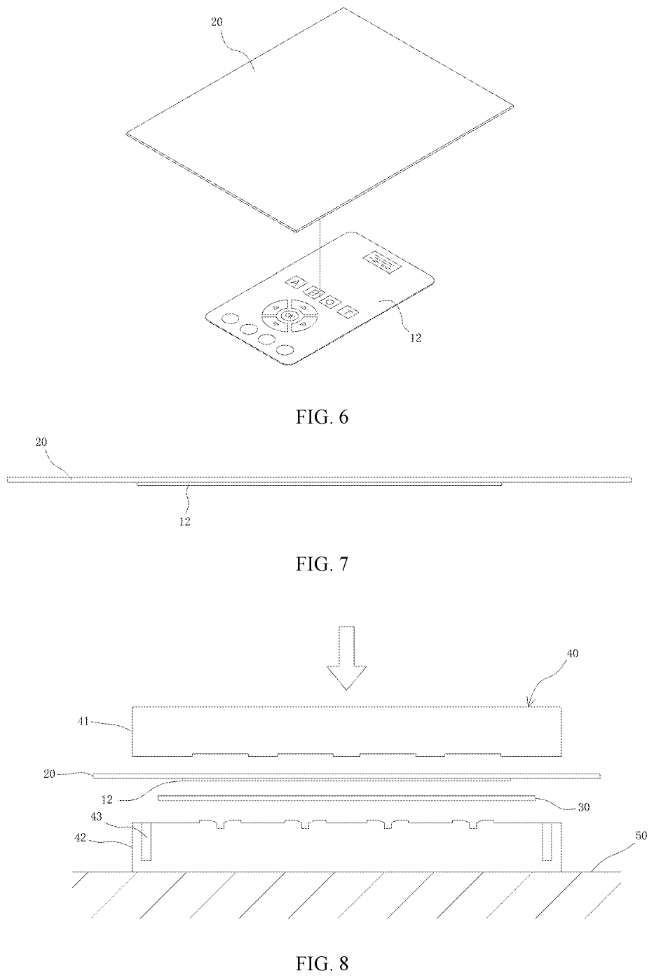

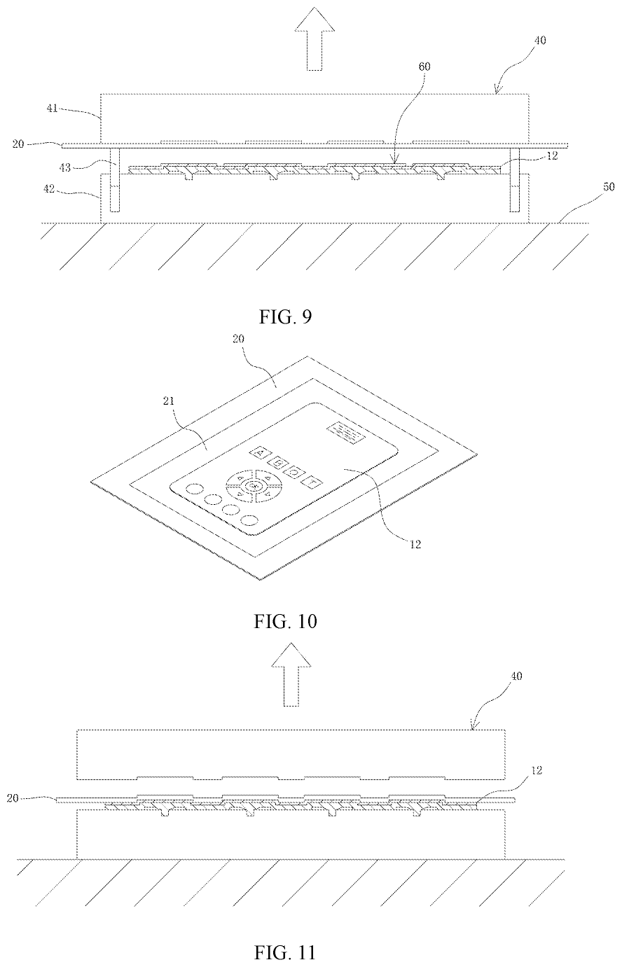

With reference to FIGS. 4 to 9, to form the foregoing rubber product, a method for printing the printed surface on the rubber product is provided. The method includes a pre-printing step S1, a pre-shrinking step S2, a fusing step S3, a separating step S4, and a cutting step S5.

The pre-printing step S1 first provides a plate 20, which is made of a material that has a melting point higher than that of the natural rubber material and may be selected from one of plastic materials, for example, PC (Polycarbonate), TPU (Thermoplastic Polyurethane), PET (Polyethylene Terephthalate), or the like, then heats the plate 20 to preshrink it, and pre-prints inks made of the natural rubber material on the plate 20 to form the printed surface layer 12 on the plate 20. The printed surface layer 12 may have at least one pattern or at least one label each of which is printed with multiple colors. Given as one example, the at least one pattern includes the key button region 13 and the at least one label includes the label region 14 as shown in FIG. 1. Besides, the printed surface layer 12 may have multiple colors, at least one pattern, or at least one label printed on the plate 20 printed on the plate 20 by way of multi-layer printing or in a three-dimensional (3D) form.

The pre-shrinking step S2 shrinks the plate 20 having the printed surface layer 12 by heating the plate 20 at a high temperature for the printed surface layer 12 on the plate 20 to be shrunk to a designated form. It should be pointed out that the plate 20 will not deformed during the pre-shrinking step S2 since the plate 20 is made of the material whose melting point is higher than that of the natural rubber material. Instead, it is only the printed surface layer 12 that is shrunk by heat and gets deformed.

The fusing step S3 comes after the pre-shrinking step S2, and after the printed surface layer 12 on the plate 20 is pre-shrunk and formed on the plate 20, simultaneously places the plate 20 and a substrate 30 made of the natural rubber material into a die assembly 40 with the printed surface layer 12 adjacent to the substrate 30. The die assembly 40 includes an upper die base 41 and a lower die base 42 each of which is formed with a pre-determined contour thereon. The die assembly 40 is mounted on a stamping press machine 50 through which the upper die base 41 is moved toward the lower die base 42 to perform a pressing. After the upper die base 41 falls onto the lower die base 42, the fusing step S3 further heats the upper die base 41 and the lower die base 42 for the substrate 30 to form the base 11 through a sulfurization process inside the die assembly 40 at a high temperature and a high pressure. A molten state occurring on surfaces of the base 11 can be resulted from the sulfurization process. As both the printed surface layer 12 and the base 11 are made of the natural rubber material, the homogeneous material property causes adjacent surfaces of the base 11 and the printed surface layer 12 to be fused together in the course of the sulfurization process, such that the printed surface layer 12 and the base 11 are formed as one piece due to fused connection. Meanwhile, the base 11 can be shaped into a predetermined form and the effect of transfer-printing the printed surface layer 12 from the plate 20 to the base 11 can be also achieved.

The separating step S4 serves to separate the plate 20 from the printed surface layer 12. Because the plate 20 and the printed surface layer 12 in the present embodiment are made of different materials and the melting point of the plate 20 is higher than that of the printed surface layer 12, the plate 20 inside the die assembly 40 will not be fused with the printed surface layer 12 in the fusing step S3. After the printed surface layer 12 and the base 11 are fused as a whole to form a preliminary workpiece 60 and the die assembly 40 is chilled down, an injection mechanism 43 mounted on the lower die base 42 pushes the plate 20 upwards to separate it from the printed surface layer 12. Additionally, in the present embodiment, an injection technique that separates the plate 20 and the printed surface layer 12 inside the die assembly 40 is adopted. Nevertheless, in practical applications, after the printed surface layer 12 and the base 11 are fused and cooled, they can be removed from the die assembly 40 and the plate 20 can then be torn off from the printed surface layer 12 to alternatively achieve the separating step S4.

The cutting step S5 cuts the preliminary workpiece 60 into a predetermined shape of the rubber product as shown in FIG. 1 after the base 11 and the printed surface layer 12 are fused inside the die assembly 40, thereby allowing the printed surface layer 12 to be formed on the rubber product 10. The cutting step S5 here enables to cut the preliminary workpiece 50 into the rubber product 10 regardless of whether the preliminary workpiece 59 is inside the die assembly 40 or is removed from the die assembly 40. (As being conventional techniques, either way of cutting the preliminary workpiece 50 is not elaborated here.)

What is worth mentioning is that owing to the sulfurization process generated through the high temperature and pressure inside the die assembly 40, adjacent surfaces of the base 11 and the printed surface layer 12 can be fused together. Hence, the printed surface layer 12 and the base 11 have not only a better bonding strength therebetween but better resistance against abrasion and corrosion.

With reference to FIGS. 10 and 11, in the present embodiment, when a bridging layer 21 is mounted between the plate 20 and the printed surface layer 12, the bridging layer 21 serves to bridge the printed surface layer 12 and the plate 20, thus allowing the printed surface layer 12 and the plate 20 to be bridge-connected. After the sulfurization process at high temperature and pressure is carried out inside the die assembly 40 for the plate 20 and the base 11, the plate 20 can be kept on the printed surface layer 12 and the plate 20 can be used as a protection layer for the printed surface layer 12. Doing so can certainly enhance the abrasion resistance of the printed surface layer 12 and in the meanwhile make the printed surface layer 12 more vivid in color. When applied to certain special products, such as outdoor products, control panels, key boards, and the like, which need to be protected against grease, the plate 20 can prevent grease from being in direct contact with the rubber product (as shown in FIG. 1), thus prolonging the life duration of the rubber product 10.

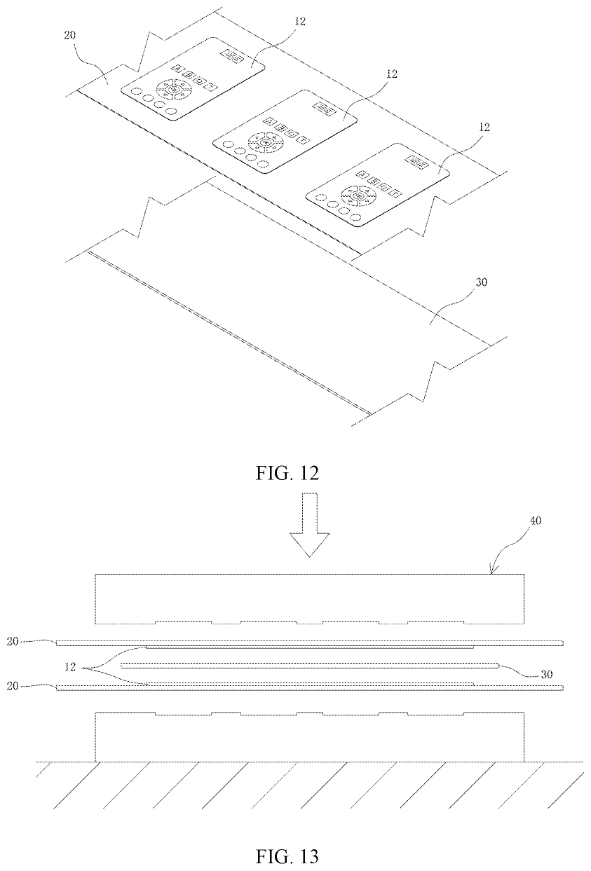

With reference to FIGS. 8 and 12, in the present embodiment, the plate 20 and the substrate 30 can be made to take a strip form with a plenty of the printed surface layers 12 separately printed on the plate 20. As a result, the plates 20 on the strip form and the substrate 30 can be fed into the die assembly 40 through a strip belt conveyor to attain the effect of production automation, which not only meets the demand of mass production but effectively increases production efficiency.

With reference to FIG. 13, the present embodiment is dedicated to ensure a double-sided printing effect on the substrate 30 inside the die assembly 40. What it takes is to simultaneously mount two of the foregoing plates 20 on both top and bottom sides of the substrate 30 with two of the foregoing printed surface layers 12 on the respective plates 20 adjacent to the top and bottom sides of the substrate 30 respectively, such that the double-sided printing effect can be realized through the sulfurization process inside the die assembly 40 at the high temperature and pressure.

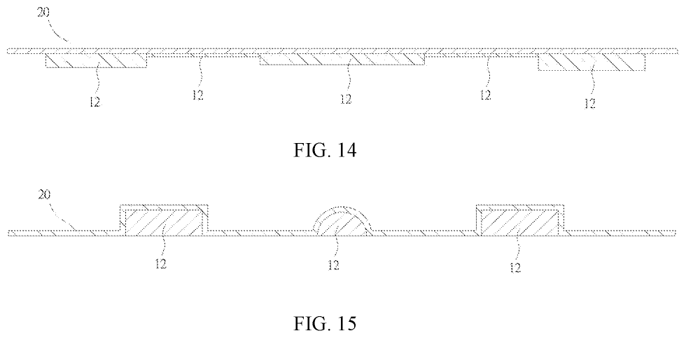

With reference to FIG. 14, the present embodiment serves to form the printed surface layer 12 on the heated and pre-shrunk plate 20 with various colors and height variation by way of screen-printing varying in screen mesh thickness, thereby achieving 3D transfer-printing effect or multi-colored transfer-printing effect.

Lastly, with reference to FIG. 15, the present embodiment serves to simultaneously form various indentations, such as dome-shaped indentation or rectangular indentation, patterns, or texts on the plate 20 which is malleable, by heating and pressing the plate 20 while the plate 20 is conducted with the pre-shrinking processing. Subsequently, ink containing the natural rubber material is filled in the indentations to generate the printed surface layer 12 by way of screen-printing or drop-on-demand printing, such that the plate 20 can be also utilized to fulfill the 3D transfer-printing effect.

In sum, the present invention pre-prints inks containing the natural rubber material on the plate 20 to form the printed surface layer 12, places the plate 20 printed with the printed surface layer 12 and the substrate 30 made of the natural rubber material into the die assembly 40, and performs the sulfurization process for adjacent surfaces of the printed surface layer 12 and the base 11 to be fused together and for the printed surface layer 11 to be transfer-printed on the base 12. As such, besides the enhanced product durability, such as capability withstanding special chemical substances and enhanced abrasion-resistant capability, multiple colors, patterns or 3D forms can be transfer-printed at the same time. Therefore, the rubber product and the method for forming the printed surface can provide superior applicability and productivity and what the mechanism and the production method involved are novel and totally unconventional.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1-4. (canceled)

5. A method for forming a printed surface on a rubber product, comprising:
a pre-printing step forming a printed surface layer on at least one plate heated and pre-shrunk beforehand, wherein the printed surface layer on the at least one plate is printed on the plate with an ink containing a crude natural rubber material; wherein the pre-printing, step comprises forming the printed surface layer having a pattern with a plurality of colors on the at least one plate that is heated and pre-shrunk beforehand;
a pre-shrinking step heating the at least one plate for the printed surface layer on the at least one plate to be shrunk to a designated form;
a fusing step simultaneously placing the at least one plate and a substrate made of a crude natural rubber material into a die assembly with the printed surface layer on the at least one plate adjacent to the substrate, heating and pressing the at least one plate and the substrate inside the die assembly together for the substrate to form a base through a sulfurization process, and fusing adjacent surfaces of the base and the printed surface layer on the at least one plate together during the sulfurization process to form a preliminary workpiece; and
a cutting step cutting the preliminary workpiece into a predetermined shape to form the rubber product with the at least one printed surface layer.

6. The method of claim 5, wherein the at least one plate is made of a material that has a melting point higher than that of the crude natural rubber material.

7. (canceled)

8. The method of claim 5, wherein in the cutting step, the preliminary workpiece is cut when the preliminary workpiece is inside the die assembly.

9. The method of claim 5, further comprising a separating step removing the at least one plate from the at least one printed surface layer respectively after the preliminary workpiece is formed.

10. (canceled)

11. The method of claim 5, wherein the at least one plate includes two plates with two printed surface layers formed on the respective plates and the two printed surface layers are arranged to be adjacent to two opposite sides of the substrate in the fusing step.

12. The method of claim 5, wherein during the sulfurization process of the substrate made of the crude natural rubber material and the printed surface layer containing the crude natural rubber material, portions with varying heights are formed on the rubber product and comprise a key button region and a label region.

13. The method of claim 6, wherein the material of the at least one plate is selected from one of PC (Polycarbonate), TPU (Thermoplastic Polyurethane), PET (Polyethylene Terephthalate).

14. The method of claim 5, wherein in the cutting step the preliminary workpiece is cut after the preliminary workpiece has been removed from the die assembly.

15. The method of claim 5, wherein in the pre-printing step the printed surface layer comprises at least one selected from the group consisting of a plurality of colors, a pattern, and a label printed on the plate by way of multi-layer printing.

16. The method of claim 5, wherein in the pre-printing step the printed surface layer comprises at least one selected from the group consisting of a plurality of colors, a pattern, and a label printed on the plate in a three-dimensional (3D) form.

17. The method of claim 5, wherein the fusing step comprises: after the printed surface layer is formed on the plate and heated and pre-shrunk, simultaneously placing the plate having the printed surface layer containing the crude natural rubber material together with the substrate made of the crude natural rubber material into a die assembly, with the printed surface layer placed adjacent to the substrate, wherein the die assembly comprises an upper die base and a lower die base each of which is formed with a pre-determined contour, and wherein the die assembly is mounted on a stamping press machine through which the upper die base is moved towards the lower die base to perform pressing; after the upper die base falls into the lower die base, heating the upper die base and the lower die base and subjecting the substrate made of the crude natural rubber material and the printed surface layer containing the crude natural rubber material to a sulfurization process inside the die assembly at a high temperature and a high pressure, where a molten state is triggered on surfaces of the substrate from the sulfurization process, and adjacent surfaces of the substrate and the printed surface layer are caused to be fused together in the course of the sulfurization process, so that the printed surface layer and the substrate are formed as one piece due to fused connection and the printed surface layer is transfer-printed from the plate to the substrate.

18. The method of claim 17, wherein the lower die base comprises an lifting structure configured to push the plate upwards to separate it from the printed surface layer that has been fused together with the substrate by the fusing step, wherein the plate has a larger area than the printed surface layer and wherein the printed surface layer is disposed on a center of the plate and spaced apart from edges of the plate, wherein the method further comprises a separating step immediately subsequent to the fusing step, the separating step comprising:
after the printed surface layer and the base are fused as a whole to form the preliminary workpiece and the die assembly cools down, pushing, by the lifting structure, margins of the plate clear of the printed surface layer to move the plate upwards to be separated from the printed surface layer.

19. The method of claim 5, wherein there is further mounted a bridging layer between the plate and the printed surface layer, the bridging layer being configured to bridge-connect the printed surface layer and the plate, and after the sulfurization process at high temperature and pressure is carried out inside the die assembly for the plate and base, the plate is kept on the printed surface layer and used as a protection layer for the printed surface layer to enhance an abrasion resistance of the printed surface and make the printed surface layer have vivid colors.

20. The method of claim 5, wherein the plate and the substrate each are of a form of a long strip, with a plurality of printed surface layers separately printed on the strip-form plate, and wherein the plate and the substrate are fed into the die assembly through a strip belt conveyor to achieve automated and batch production.

21. The method of claim 5, wherein the pre-printing step comprises creating a plurality of indentations in the plate by heating and pressing the plate while the plate is subjected to the pre-shrinking process, and subsequently filling the ink containing the crude natural rubber material in the plurality of indentations to create the printed surface layer by way of screen-printing or drop-on demand printing, thus achieving 3D transfer-printing.
